(19) United States
(12) Patent Application Publication
(10) Pub. No.: US 2008/0244484 A1
(43) Pub. Date: Oct. 2, 2008

(54) CIRCUIT DESIGN VERIFICATION SYSTEM, METHOD AND MEDIUM

(76) Inventor: MASAHITO KUMAZAKI, Tokyo (JP)

Correspondence Address: Jackson Chen;NEC Corporation of America, 6535 N. State Hwy. 161, Irving, TX, 75039, US

(21) Appl. No.: 12/058,136

(22) Filed: Mar. 28, 2008

(30) Foreign Application Priority Data
Mar. 28, 2007 (JP) 2007-083610

(51) Int. Cl. G06F 17/50

(52) U.S. Cl. 716/5

(57) ABSTRACT

A common-signal-terminal extracting section extracts common signal terminals from a netlist of the semiconductor device. An information converting section replaces the information of circuit components connected to the extracted common signal terminals by electric property information with reference a circuit-component library. A conformity detecting section determines whether or not the electric property information meets an electrical constraint rule with reference to an electrical constraint rule of the common signal terminals. An unverified-netlist creating section creates an unverified netlist from the netlist after excluding information of the common signal terminals. A simulation executing section executes logical simulation based on the created unverified netlist.

This application is based upon and claims the benefit of priority from Japanese patent application No. 2007-083610 filed on Mar. 28, 2007, the disclosure of which is incorporated herein in its entirety by reference.

### BACKGROUND OF THE INVENTION

1. Field of the Invention

The present invention relates to circuit-design verification system, method and medium, and more particularly, to circuit-design verification system, method and medium which are suitable for verifying the validity of the design of a semiconductor device including a printed wiring board (or circuit board) and LSI chips mounted on the printed wiring board.

2. Description of the Related Art

In general, a semiconductor device includes at least one LSI and at least one circuit component which are mounted on a printed wiring board (PWB). The semiconductor device having such a structure is installed in an electronic apparatus. In the recent development of the PWB accompanied by an increase in the operational speed and pattern density as well as the complexity of required functions of the semiconductor devices, the design of the PWB has become complicated. In the PWB, in particular, since the circuit components such as resistors and capacitors are mounted on the circuit board, logical and electrical simulations are both required, which requires a great deal of time (TAT: turn around time) for verification of the validity of the design for the semiconductor devices.

In the conventional verification technique, since a great deal of TAT is consumed for a device-level logical simulation, a technique of pseudo-modeling a simulation model is adopted for the purpose of reducing the TAT. In this pseudo-modeling technique, resistors, capacitors and common signal terminals including power source terminals and ground terminals are not the target for the device simulation. Therefore, a visual inspection on these circuit components is indispensable instead of the simulation. Additionally, an analog circuit cannot be a target for the logical simulation. Therefore, verification of the analog circuit needs to depend on a visual inspection together with resistors, capacitors, power source terminals and ground terminals. Such a verification using the visual inspection requires a great deal of TAT and often involves an error of verification.

Further, in an electrical verification executed after the logical verification, if there is a terminating connection between bidirectional buffers, it is impossible to discriminate between the termination and a clamp only from the circuit configuration, and verification cannot be carried out without referring to logical information added thereto. Thus, a great deal of TAT has been needed also from this aspect.

Furthermore, as is often the case with the connection of common signal terminals through which analog signals, current signals or voltage signals pass, specifications thereof are submitted by an LSI vendor, whereby priority is often placed on the presence itself of the terminals described in the specifications rather than on the validity thereof. In this case either, the verification of the connection generally needs to depend on the visual inspection, giving rise to a problem such as human errors.

In Patent Publication JP-1998-254938-A1, a technique is described in which, during simulating a digital-to-analog mixed circuit, an analog circuit is converted into a circuit model suitable for a digital simulation. In this publication, the analog circuit components are converted to suitable digital signal components by using a specific conversion rule. For example, power supply circuits and a ground network are deleted, and resistors and capacitors are automatically replaced each by a through gate, a delay gate, or the like.

According to the technology described in JP-1998-254938-A1, a circuit portion having common signal terminals through which analog signals pass is converted into a circuit model suitable for logical simulation, which makes possible a reduction in the TAT of a simulation. However, a model for converting an analog circuit portion into an appropriate gate may entail the problem that the obtained verification result lacks precision. Further, since the power supply circuits and ground network are excluded from the target of verification, these portions are necessary to be visually inspected. This involves a limitation on the reduction of TAT.

### SUMMARY OF THE INVENTION

The present invention has been made in view of the foregoing problems of the conventional technique, and it is therefore an object of the present invention to provide circuit-design verification system, method and medium which, in particular, are used suitably for simulation in design verification of a semiconductor device including a PWB in order to verify the logical and electrical validity of the circuit configuration, and which can facilitate an automated design verification using simulations while reducing the necessity of visual inspection during the verification.

The present invention provides, in a first aspect thereof, a circuit-design verification system for verifying a circuit design of a semiconductor device, including: a common-signal-terminal extracting section for extracting, from a netlist of the semiconductor device, common signal terminals included in the netlist; an information converting section for replacing information of circuit components connected to the extracted common signal terminals by electric property information with reference to a storage device that stores therein a circuit-component library; a conformity detecting section for determining whether or not the electric property information meets an electrical constraint rule with reference to a storage device that stores therein a rule file in which the electrical constraint rule of the common signal terminals is described; an unverified-netlist creating section for creating an unverified netlist from the netlist after excluding information of the extracted common signal terminals and corresponding circuit components from the netlist; and a simulation executing section for executing at least logical simulation on the created unverified netlist.

The present invention also provides, in a second aspect thereof, a method for verifying a circuit design of a semiconductor device, including: extracting, from a netlist of the semiconductor device, common signal terminals included in the netlist; replacing information of circuit components connected to the extracted common signal terminals in the netlist by electric property information with reference to a storage device that stores therein a circuit-component library; determining whether or not the electric property information meets an electrical constraint rule of the common signal terminals with reference to a storage device that stores therein a rule file in which the electrical constraint rule is described; excluding information of the extracted common signal terminals and corresponding circuit components from the netlist, to thereby create an unverified netlist; and executing at least logical simulation on the created unverified netlist.

The present invention further provides, in a third aspect thereof, a computer readable medium encoded with a computer program on which a control processing unit (CPU) is run for verifying a circuit design of a semiconductor device, said program being capable of causing said CPU to: extract, from a netlist of the semiconductor device, common signal terminals included in the netlist; replace information of circuit components connected to the extracted common signal terminals in the netlist by electric property information with reference to a storage device that stores therein a circuit-component library; determine whether or not the electric property information meets an electrical constraint rule of the common signal terminals with reference to a storage device that stores therein a rule file in which the electrical constraint rule is described; exclude information of the extracted common signal terminals and corresponding circuit components from the netlist, to thereby create an unverified netlist; and execute at least logical simulation on the created unverified netlist.

The term “netlist” as used in the present invention means the list of interconnections or wirings in the design of a semiconductor device. The term “net” means an interconnection or wiring in the design.

The above and other objects, features and advantages of the present invention will be more apparent from the following description, referring to the accompanying drawings.

### BRIEF DESCRIPTION OF THE DRAWINGS

FIG. 1 is a block diagram showing a circuit-design verification system according to an embodiment of the present invention;

FIG. 2 is a flowchart showing processing of the circuit-design verification system of FIG. 1;

FIG. 3A is a circuit diagram exemplifying a target circuit described in a PKG netlist, and FIG. 3B is a data list exemplifying data of the resistor/capacitor library;

FIG. 4A is a data list exemplifying an LSI rule file, and FIG. 4B is a circuit diagram exemplifying a circuit described in the intermediate netlist;

FIG. 5A is a data list showing verification results of common signal terminals, FIG. 5B is a circuit diagram exemplifying a circuit described in the unverified netlist, and FIG. 5C is a circuit diagram exemplifying the pseudo-device SIM model; and

FIG. 6A is a data list showing logical-verification results of a device and FIG. 6B is a data list showing an I/O model of the device.

### DETAILED DESCRIPTION OF THE INVENTION

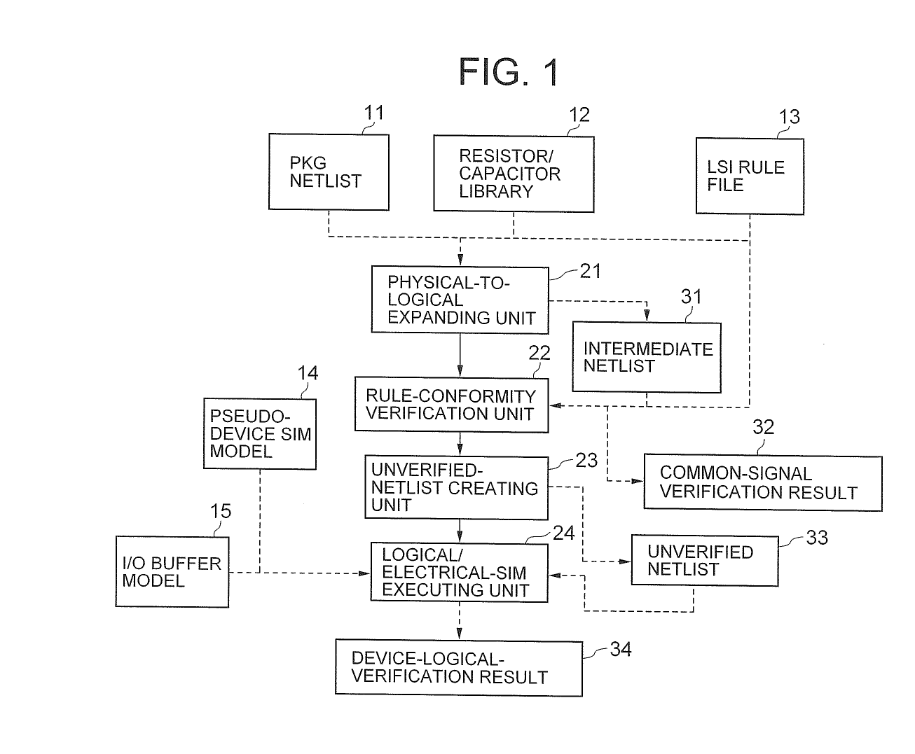

Hereinafter, circuit-design verification system, method and medium according to an exemplary embodiment of the present invention will be described with reference to the accompanying drawings. FIG. 1 is a block diagram showing a circuit-design verification system according to the present embodiment. The circuit-design verification system includes: a physical-to-logical expanding unit 21; a rule-conformity verification unit 22; an unverified-netlist creating unit 23; and a logical/electrical-SIM executing unit 24.

The physical-to-logical expanding unit 21 receives a PKG netlist 11, refers to a resistor/capacitor library 12 and an LSI rule file 13, and expands (or converts) information of the circuit components connected to common signal terminals in the circuit design into electric property information. More specifically, the physical-to-logical expanding unit 21 has a function of expanding the physical information of the resistors and capacitors to the logical information thereof with reference to a resistor/capacitor library 12 and LSI rule file 13.

The rule-conformity verification unit 22 refers to the LSI rule file 13 to verify an intermediate netlist 31 output from the physical-to-logical expanding unit 21. The unverified-netlist creating unit 23 extracts unverified nets from the PKG netlist 11 to create an unverified netlist 33. The logical/electrical-SIM executing unit 24 performs simulation (SIM) verification using the known technique with respect to the unverified netlist 33 and an I/O buffer model 15.

The physical-to-logical expanding unit 21 includes a common-signal-terminal extracting section for extracting a common signal terminal from the netlist of the semiconductor device, and an information converting section for replacing information of the circuit components connected to the thus extracted common signal terminal by electric property information of the circuit components. The logical/electrical-SIM executing unit 24 outputs a device-logical-verification result 34. Each of the above-described sections can be realized by a program to be loaded in a computer that executes a circuit design verification.

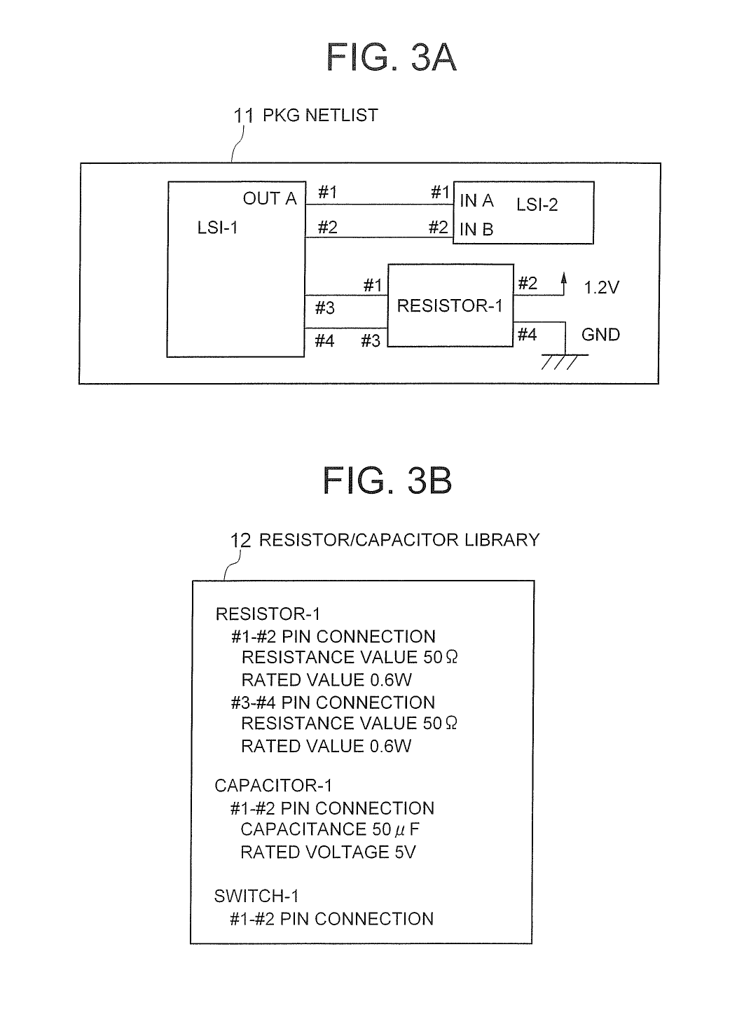

FIGS. 3 to 6 respectively exemplify input design data of the semiconductor device that is verified by the circuit-design verification system, intermediate data that is obtained in the circuit-design verification system, and output data of the circuit-design verification system. In the PKG netlist 11, the connection relationship of all the circuit components described in the circuit of the wiring board, which is the target of the design verification, is defined. FIG. 3A shows the configuration of the circuit described in the PKG netlist 11. In this example, LSI-1 and LSI-2 are mounted on the PWB. The LSI-1 is pulled up to a power source voltage (1.2 V) and pulled down to a ground voltage (GND) through a resistance module-1. The resistor/capacitor library 12 defines the electric property of circuit components, such as resistance, capacitance and rated value, and relationship between terminals of these components.

The resistor/capacitor library 12 defines ratings and connection relationship of the circuit components which have already been subjected to verification of the design in the past and for which the validity has been confirmed by the verification. The content of the resistor/capacitor library 12 is shown in FIG. 3B. In this example, the resistor/capacitor library 12 defines the rated value of resistors and capacitors, and the connection relationship of circuit components which are capable of being degenerated, such as switch, connector, and the like. The resistor-1, for example, configures a resistor module including two resistor elements.

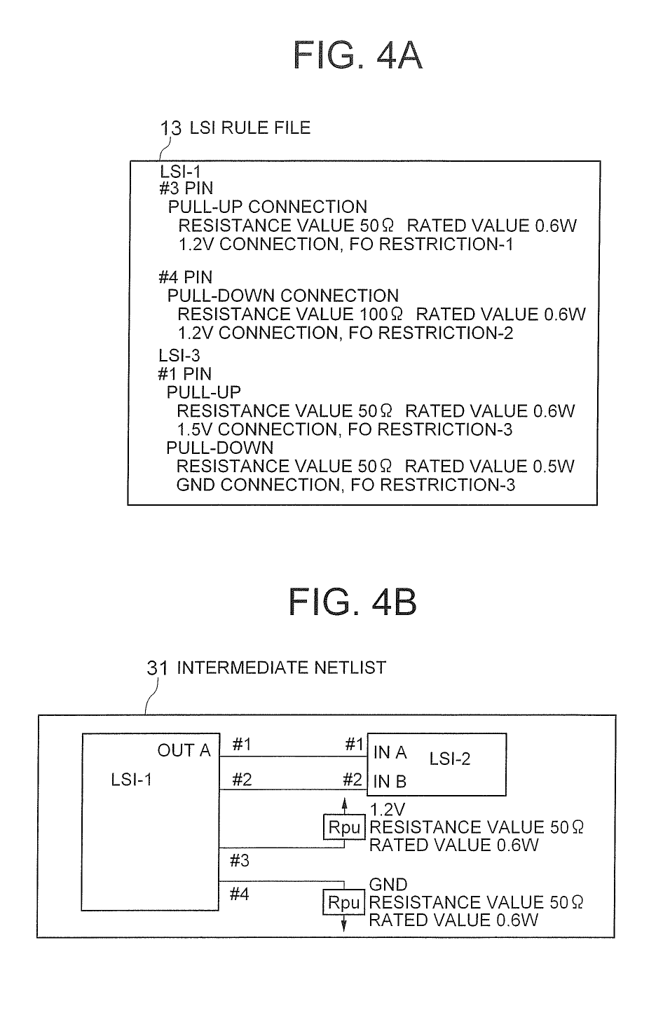

The LSI rule file 13 defines connection rules with respect to the common signal terminals of all the LSIs which were adopted in product devices in the past and have been introduced as library information. In the example shown in FIG. 4A, electrical constraint rules for the respective common signal terminals of the LSIs are represented. The electrical constraint rules include usage of each common signal terminal in the design, e.g., as to whether the terminal establishes a pull-up connection or pull-down connection, or as to resistance value, rated value and a connection voltage of the resistor to be connected to the common signal terminal, and capacitance value, rated value and connection voltage of the capacitor to be connected to the common signal terminals, and the number of fan-outs allowed to the common signal terminals.

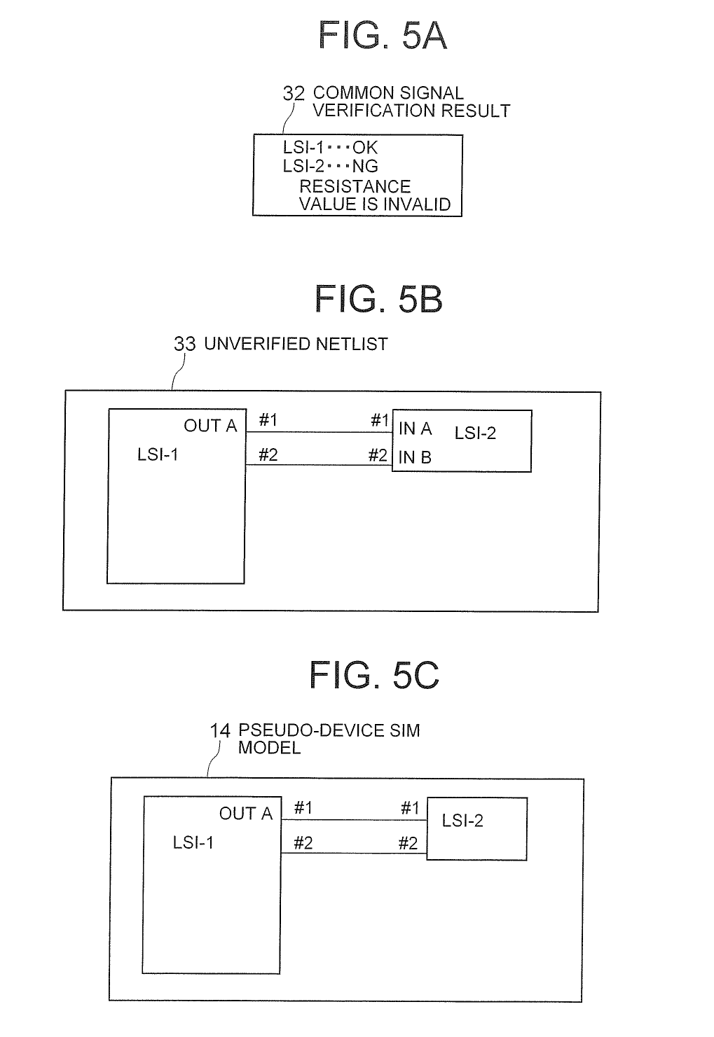

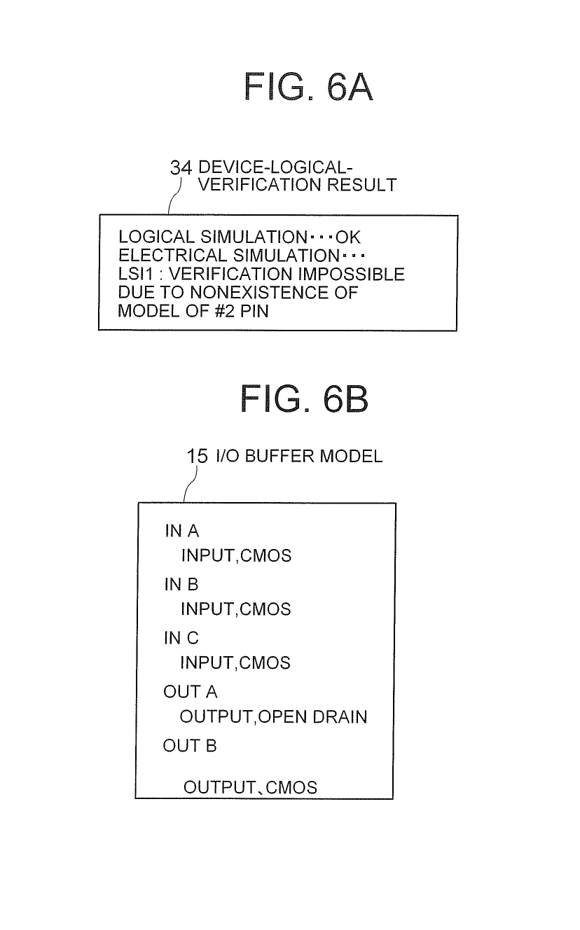

The intermediate netlist 31 is output from the physical-to-logical expanding unit 21. As shown in FIG. 4B, the intermediate netlist 31 is obtained by adding electric property information to the netlist. FIG. 4B shows the electric property information of the resistor and capacitor which are the circuit components extracted from the netlist and are to be connected to the common signal terminals. FIG. 4B also shows the electric property information of switch and connector in the state where the connection information of switch and connector is degenerated. The common-signal verification result 32 shows a verification result of the common signal terminals which were subjected to the verification (FIG. 5A). By excluding, from the intermediate netlist 31, information of the common signal terminals which were subjected to the verification, the unverified netlist 33 shown in FIG. 5B is obtained. Logical verification is executed by applying the pseudo-device SIM model 14 shown in FIG. 5C, which were subjected to the logical verification, to the unverified netlist 33. As a result, the device-logical-verification result 34 shown in FIG. 6A is obtained for the semiconductor device. Information listed in I/O buffer model 15 shown in FIG. 6B is added to the LSIs of the semiconductor device which was subjected to the device logical verification, and then, simulation of the electrical verification is executed to the semiconductor device. The I/O buffer model 15 defines classification of input and output of I/O buffer and configuration of the buffer.

The physical-to-logical expanding unit 21 uses the information of the above-described PKG netlist 11, resistor/capacitor library 12 and LSI rule file 13, and has the functions of: extracting the configuration of the circuit components to be connected to the common signal terminals, the circuit components capable of being degenerated so as to exclude the physical information thereof; and creating the electric property information to thereby generate the intermediate netlist 31. The rule-conformity verification unit 22 has functions of receiving the intermediate netlist 31, and executing a conformity inspection between the netlist 31 and the connection rule defined by the LSI rule file 13 to thereby generate the common-signal verification result 32.

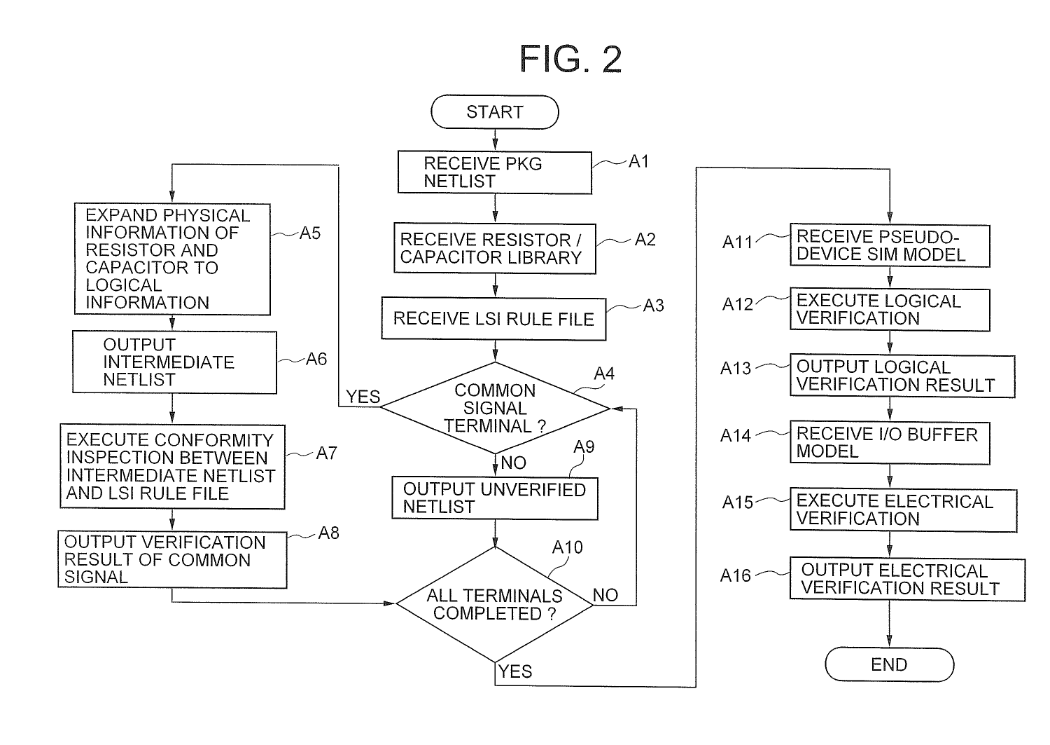

FIG. 2 is a flowchart showing processing of the circuit-design verification system of FIG. 1. Firstly, the circuit-design verification system receives information of the PKG netlist 11, resistor/capacitor library 12 and LSI rule file 13 (steps A1 to A3). Then, the circuit-design verification system sequentially selects terminals described in the PKG netlist 11, and determines whether or not the a selected terminal is a common signal terminal defined by the LSI rule file 13 (step A4). If it is determined that the selected terminal is a common signal terminal in step A4, the process advances to step A5, and if not, the process advances to step A9.

The physical-to-logical expanding unit 21 expands the physical information of the common signal terminal to the logical information thereof. In this step, the connection information between the circuit components including the resistor, capacitor, connector, switch, connector pin, and the like, which are to be connected to the common signal terminal, is acquired by the resistor/capacitor library 12. For the resistor component, information of the resistance value, rated value, and connection voltage is added. For the capacitor component, information of the capacitance, rated value and connection voltage is added. The information items on the switch component and connector component are degenerated. A similar processing is carried out again for the connection of the other terminals, and the thus obtained results are output as the intermediate netlist 31 (step A6).

Next, the rule-conformity verification unit 22 inspects as to the conformity between the intermediate netlist 31 and the LSI rule file 13. The validity of resistance value, rated value, connection voltage and number of fan-outs is examined for a resistor component, whereas the validity of capacitance value, rated value, connection voltage, and number of fan-outs is examined for a capacitor component (step A7). The result of conformity inspection carried out by the rule-conformity verification unit 22 is output as the common-signal verification result 32 (step A8).

On the other hand, if the terminal selected from the netlist is determined not to be a common signal terminal in step A4, the unverified-netlist creating unit 23 outputs connection information of the selected terminal to the unverified netlist 33 (step A9). In step A10, whether or not all terminals have been subjected to the processing is checked. If not, the determination of step A4 is carried out for the terminals which have not yet been subjected to the processing, and the subsequent processing is carried out. After all the terminals have been subjected to the processing, the process advances to step A11. After the processing of all the terminals is completed, it means that the verification processing including the logical verification and electrical verification for the common signal terminals has already been completed, whereby the verification result is output to the common-signal verification result 32. The connection information of the terminals other than the verified common signal terminals is listed in the unverified netlist 33.

Subsequently, the logical/electrical-SIM executing unit 24 carries out verification for the unverified netlist 33. The verification includes both the logical and electrical verifications. In the logical verification, the pseudo-device SIM model 14 which was subjected to the logical SIM using the conventional technique is input (step A11), and a conformity inspection is conducted between the pseudo-device SIM model 14 and the unverified netlist 33, to thereby carry out the logical verification (step A12). FIG. 5C exemplifies the pseudo-device SIM model 14. Here, the common signal terminals which have already been subjected to the verification are excluded. It is to be noted that, in this logical verification, the conformity inspection is not necessarily carried out, and a normal logical verification can be carried out for the unverified netlist 33 (FIG. 5B). The verification result is output as the device-logical-verification result 34 (step A13). In the device-logical-verification result 34, the result information is output indicating that the logical simulation has successfully been carried out, together with the information of error indicating that no data of #2 pin of LSI-1 exists (FIG. 6A). The error information shows that the LSI having the #2 pin is not registered in the rule file of library. In this case, a rule file is created and registered for the data of the #2 pin, or otherwise verification processing is carried out, e.g., visually.

The electrical verification is performed after the step of inputting the I/O buffer model 15 into the unverified netlist 33 of FIG. 5B (step A14). The electrical verification is carried out by use of a conventional technique, e.g., transmission path simulation (step A15). An example of the I/O buffer model 15 is shown in FIG. 6B. The verification result is output to the device-logical-verification result 34 (FIG. 6A) (step A16).

A concrete example of the verification processing for the netlist will now be described further with reference to FIGS. 3 to 6. Firstly, input of the PKG netlist 11 (FIG. 3A), input of the resistor/capacitor library 12 (FIG. 3B), and input of the LSI rule file 13 (FIG. 4A) are consecutively carried out (steps A1 to A3). Thereafter, entire connection information of the PKG netlist 11 is recognized. Whether or not the terminals described in the PKG netlist 11 are a common signal terminal is sequentially inspected (step A4). Here, since first pin (#1 pin) of the LSI-1 is not defined in the LSI rule file 13, it is determined that the #1 pin is not a common signal terminal, and the connection between the #1 pin of the LSI-1 and #1 pin of the LSI-2, which establishes a connection for the #1 pin of the LSI-1, is registered in the unverified netlist 33 (step A9).

Similarly, since #2 pin of the LSI-1 is not a common signal terminal (step A4), the connection between the #2 pin of the LSI-1 and the #2 pin of the LSI-2 is registered in the unverified netlist 33 (step A9). Since #3 pin of the LSI-1 is defined in the LSI rule file 13, it is determined that the #3 pin is a common signal terminal (step A4). Further, the connection destination of the #3 pin of the LSI is #1-#2 pin of the resistor-1, which is defined in the resistor/capacitor library 12. Thus, the physical information of the resistor-1 is converted into 50Ω and 0.6 W, which are a resistance value and a rated value, respectively, defined in the resistor/capacitor library 12, and converted into 1.2 V, which is a voltage of the connection destination described in the PKG netlist 11 (step A5). These converted values are output to the intermediate netlist 31 shown in FIG. 4B (step A6).

Subsequently, conformity of information of the intermediate netlist 31 and #1 pin of the LSI-1 of the LSI rule file 13 is inspected. In this case, both the netlist 31 and the LSI rule file 13 show a conformity of the resistance value of 50Ω, rated value of 0.6 W and connection voltage of 1.2 V, and further, the number of fan-outs is within a restricted value of 1. The result of inspection is determined to be valid (step A7). Therefore, the result is output to the common-signal verification result 32 together with a note, “LSI-1—OK” (step A8). Similarly, information of #4 pin of the LSI-1 is expanded on the intermediate netlist 31 (steps A4 to A6). Here, the resistance value shown on the intermediate netlist 31 is 100Ω and that shown in the LSI rule file 13 is 50Ω, which do not indicate a conformity. Therefore, the result is output to the common-signal verification result 32 together with a note of “LSI-2—NG; the resistance value is invalid” (step A8).

After the determination processing of all the terminals or output processing to the intermediate netlist is completed (step A10), it is concluded that the verification of the common signal terminals have been completed, and that the unverified parts are extracted in the unverified netlist 33. The following verification processing is executed by use of a conventional technique. As for the logical verification, the pseudo-device SIM model 14 is input in which the connection of common signal terminals is omitted (step A11), and based on the determination of conformity, logical verification of the unverified netlist 33 is carried out (step A12). The verification result is output to the device-logical-verification result 34 together with a note: “logical simulation—OK” (step A13).

Similarly, a conventional technique is used also for electrical verification. More specifically, the I/O buffer model 15 is input (step A14), and a transmission path simulation is carried out (step A15). The verification result is output to the above device-logical-verification result 34 (step A16). The #2 pin of the LSI-1 cannot be verified because its buffer model cannot be identified. The verification result with a note to the effect that verification is failed is output to the device-logical-verification result 34.

In the present embodiment, terminals described in the netlist are classified into common signal terminals and terminals other than the common signal terminals. The common signal terminals are verified using a rule file, and the other terminals are applied to conventional simulations. Such a technique can improve the verification efficiency without reducing verification items in the logical and circuit simulations or without using an inadequate simple verification model.

The simulation for electrical verification is substituted by executing verification of a common signal using the netlist/rule-conformity verification unit 22 for the intermediate netlist 31 generated by the physical-to-logical expanding unit 21, to create the common-signal verification result 32. Additionally, as for the unverified netlist 33 for which the verification has not yet been carried out by the unverified-netlist creating unit 23, unverified portions are verified using the logical/electrical-SIM executing unit 24. This makes it possible to improve the verification efficiency without losing a verification quality.

As described above, in the above embodiment, the conventional logical verification of common signal terminals in which a logical simulation is carried out by approximating the resistance or the like, is replaced by a connection inspection using the electrical constraint rule described in the rule base. This makes it possible to improve verification and reduce the TAT without losing a verification quality.

Further, the conventional visual inspection on common signal terminals is replaced by the rule-based connection inspection. This makes it possible to improve the verification quality because human errors can be eliminated.

Furthermore, the conventional electrical verification of common signal terminals, carried out along with electrical simulation is replaced by the rule-based connection inspection. This makes it possible to eliminate the creation of a verification model, with a result of a reduction in the verification TAT.

Further, the conventional electrical verification of common signal terminals, carried out along with electrical simulation is replaced by the rule-based connection inspection using a bidirectional signal with logical information imparted thereto. Therefore, the necessity of imparting the logical information is eliminated, and thus, the verification efficiency is improved.

Moreover, in the conventional rule-based connection check, the definition of physical information of connection destination is replaced by the definition of logical and electrical information. This makes it possible to secure a design choice in the physical design and improve the efficiency of rule creation.

As described heretofore, in accordance with the circuit-design verification system, method and medium of the above embodiment, information of the electric property of circuit components to be connected to the common signal terminals are extracted from the netlist, and whether or not the information of the electric property of these circuit components meets an electrical constraint rule is determined. Therefore, it is possible to carry out verification in simulation in which the portions in a netlist which corresponds to the common signal terminals are excluded from the netlist. Therefore, the efficiency of circuit design verification is improved, enabling the TAT of the circuit design verification to be reduced. In addition, as compared to the conventional technique in which a pseudo model is used from the start, verification quality is improved, and a setback to design modification is restrained.

While the invention has been particularly shown and described with reference to exemplary embodiment and modifications thereof, the invention is not limited to these embodiment and modifications. It will be understood by those of ordinary skill in the art that various changes in form and details may be made therein without departing from the spirit and scope of the present invention as defined in the claims.

What is claimed is:

1. A circuit-design verification system for verifying a circuit design of a semiconductor device, comprising:
a common-signal-terminal extracting section for extracting, from a netlist of the semiconductor device, common signal terminals included in the netlist;
an information converting section for replacing information of circuit components connected to the extracted common signal terminals by electric property information with reference to a storage device that stores therein a circuit-component library;
a conformity detecting section for determining whether or not the electric property information meets an electrical constraint rule with reference to a storage device that stores therein a rule file in which the electrical constraint rule of the common signal terminals is described;
an unverified-netlist creating section for creating an unverified netlist from the netlist after excluding information of the extracted common signal terminals and corresponding circuit components from the netlist; and
a simulation executing section for executing at least logical simulation on the created unverified netlist.

2. The circuit-design verification system according to claim 1, wherein the simulation executing section executes, in addition to the logical simulation, electrical simulation using information of an LSI I/O buffer.

3. The circuit-design verification system according to claim 1, wherein the circuit-component library contains at least a part of information of: a resistance value, a rated value and a connection voltage of a resistor; and a capacitance, a rated value and a connection voltage of a capacitor.

4. The circuit-design verification system according to claim 3, wherein the electrical constraint rule contains at least a part of information of: a number of fan-outs allowed to the common signal terminals; a resistance value, a rated value and a connection voltage of a resistor; and a capacitance, a rated value and a connection voltage of a capacitor.

5. A method for verifying a circuit design of a semiconductor device, comprising:
extracting, from a netlist of the semiconductor device, common signal terminals included in the netlist;
replacing information of circuit components connected to the extracted common signal terminals in the netlist by electric property information with reference to a storage device that stores therein a circuit-component library;
determining whether or not the electric property information meets an electrical constraint rule of the common signal terminals with reference to a storage device that stores therein a rule file in which the electrical constraint rule is described;
excluding information of the extracted common signal terminals and corresponding circuit components from the netlist, to thereby create an unverified netlist; and
executing at least logical simulation on the created unverified netlist.

6. A computer readable medium encoded with a computer program on which a control processing unit (CPU) is run for verifying a circuit design of a semiconductor device, said program being capable of causing said CPU to:
extract, from a netlist of the semiconductor device, common signal terminals included in the netlist;
replace information of circuit components connected to the extracted common signal terminals in the netlist by electric property information with reference to a storage device that stores therein a circuit-component library;
determine whether or not the electric property information meets an electrical constraint rule of the common signal terminals with reference to a storage device that stores therein a rule file in which the electrical constraint rule is described;
exclude information of the extracted common signal terminals and corresponding circuit components from the netlist, to thereby create an unverified netlist; and
execute at least logical simulation on the created unverified netlist.
